(19) United States
(12) Patent Application Publication
(10) Pub. No.: US 2016/0266002 A1
(43) Pub. Date: Sep. 15, 2016

(54) Fluorescent Dye Additive for Functional Fluids

(71) Applicant: Spectronics Corporation, Westbury, NY (US)

(72) Inventors: Jennifer Hunt, Holbrook, NY (US); John Duerr, Massapequa, NY (US)

(73) Assignee: Spectronics Corporation, Westbury, NY (US)

(21) Appl. No.: 15/049,518

(22) Filed: Feb. 22, 2016

Related U.S. Application Data
(60) Provisional application No. 62/130,979, filed on Mar. 10, 2015.

(51) Int. Cl. G01M 3/20; C10M 169/04; C10M 105/74; C10M 129/20; G01N 21/64; C09K 11/06

(52) U.S. Cl. CPC G01M 3/20; G01N 21/64; C09K 11/06; C10M 105/74; C10M 129/20; C10M 169/04; G01N 2021/6417; C09K 2211/1088

(57) ABSTRACT

A fluorescent dye in combination with an aviation functional fluid. The fluorescent dye is present in the functional fluid from about 0.0001% by weight to about 1% by weight. A method of detecting a leak in an aviation mechanical system that includes a functional fluid with a fluorescent dye. The method would include irradiating select areas of an airplane with a select spectrum of light, and observing an emission from the fluorescent dye.

### RELATED APPLICATION

This application is related to and claims priority from U.S. Provisional Patent Application No. 62/130,979 filed Mar. 10, 2015, the disclosure of which is incorporated herein by reference in its entirety.

### FIELD OF THE INVENTION

The invention relates to a fluorescent dye in combination with functional fluids, and a method of detecting a leak in mechanical systems that contains such fluids.

### BACKGROUND OF THE INVENTION

Functional fluids have been utilized as electronic coolants, diffusion pump fluids, lubricants, damping fluids, power transmission and hydraulic fluids. For example, there is interest in use of aqueous-based lubricants, particularly water-content hydraulic fluids, as a substitute for petroleum-based fluid due to the increasing cost of petroleum oils, the problem of flammability and the ever increasing problem of suitable disposal of contaminated or spent petroleum-based fluids. Water-content hydraulic fluids containing up to 85 percent or more water offer an obvious cost advantage over petroleum-based hydraulic fluids but, because of their viscosity, suffer the disadvantage of being susceptible to leakage, thereby resulting in loss of volumetric efficiency and markedly reducing the service life of hydraulic pumps. Although primarily used for transmitting forces, water-content hydraulic fluids must provide lubrication for impellers, support bearings, rings, gears, pistons, and the like, with a minimum of internal leakage in order to prevent excessive wear and failure of such parts.

Hydraulic fluids intended for use in the hydraulic system of aircraft for operating various mechanisms and aircraft control systems must meet stringent functional and use requirements. Among the most important requirements of an aircraft hydraulic fluid is that it be stable against oxidative and hydrolytic degradation at elevated temperatures. Moreover, aircraft hydraulic fluids must also maintain low temperature pour point as well as high auto ignition temperature, high flash and fire points and acceptable viscosity over a wide range of temperatures, e.g., from as low as −80° F. to as high as 160° F.

Most aircraft hydraulic fluids used in civilian aircraft contain some combination of phosphate esters including trialkyl phosphates, dialkyl aryl phosphate esters, alkyl diaryl phosphate esters and tri aryl phosphate esters. For example, the hydraulic fluids described in RE 37,101 to Deetman (which is incorporated herein by reference in its entirety) are said to provide superior thermal, oxidative and hydrolytic stability. A particular class of hydraulic fluid that has gained wide acceptance in the industry is available from Eastman Chemical Company, Kingsport, TN, and sold under the tradename Skydrol® LD4. This composition typically contains 18 to 25% by weight dibutyl phenyl phosphate, 50 to 60% by weight tributyl phosphate, 4 to 8% of butyl diphenyl phosphate, 5 to 10% of viscosity index improvers, 0.13 to 1% of a diphenyldithioethane as a copper corrosion inhibitor, 0.005% to about 1% by weight of a perfluoroalkylsulfonic acid salt antierosion agent, 4% to 8% by weight of an acid scavenger and about 1% by weight of 2,6-di-tertiary-butyl-p-cresol as an antioxidant.

Aerospace hydraulic fluids such as Skydrol® phosphate ester based hydraulic fluid are designed and formulated to operate in extreme environments that an aircraft is exposed to, including high pressures, large pressure differentials, high and low temperatures, and large temperature differentials. The fluid must also be erosion resistant, fire resistant and provide an acceptable operating viscosity at both high and low temperatures, for example, at temperatures in the range of −80° F. to 160° F. It is also understood that the unique operating requirements of aircraft hydraulic fluids would also apply to any additive that would be used with such fluids. More importantly, the additive must not adversely affect the performance properties of the hydraulic fluid, and must also be compatible with the fluid across a range of operating parameters and environmental conditions. For at least these reasons, hydraulic fluids that are formulated for use in aircraft are quite different than conventional industrial hydraulic fluids, and consequently, any additive that is to be used with such fluids must also be quite unique.

### SUMMARY OF THE INVENTION

The invention is directed to a fluorescent dye in combination with an aviation functional fluid. The fluorescent dye is present in the functional fluid from 0.0001% by weight to 1% by weight.

The invention is also directed to a functional fluid comprising: 20% to 99%, by weight of a phosphonate selected from the group consisting of a trialkyl phosphonate, a C₆-C₁₈ alkylphosphonates or an amine adduct thereof, a dihydrocarbyl dithiophosphate, and any one mixture thereof; and 0.0001% to 1% by weight of a fluorescent dye.

The invention is also directed to a fluid concentrate comprising: 1% by weight to 90% by weight of a fluorescent dye; and 5% to 70% of a polyoxyethylene derivative selected from polyoxyethylene glycols, polyoxyethylene organic acids or any one mixture thereof.

The invention is also directed to a fluid concentrate comprising: 1% by weight to 90% by weight of a fluorescent dye; and 0.5% to 7% by weight of one or more compounds selected from 2,4,6-trialkylphenol, a dialkylphenyl)amine, a polyphenol compound selected from the group consisting of bis(3,5-dialkyl-4-hydroxyaryl)methane, 1,3,5-trimethyl-2,4,6-tris (3,5-di-tert-butyl-hydroxyaryl)benzene, or any one mixture thereof, wherein the total amount of the one or more compounds does not exceed 20% by weight.

The invention is also directed to a method of detecting a leak in an aviation mechanical system. The method comprises; providing a fluid concentrate that includes a fluorescent dye, mixing the fluid concentrate with a functional fluid, and irradiating select areas of an airplane with a select spectrum of light to observe an emission from the fluorescent dye.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawing and the description are to be regarded as illustrative in nature, and not as restrictive.

### BRIEF DESCRIPTION OF THE FIGURE

The above and other aspects, features, and advantages of the present invention may be more apparent from the following more particular description of embodiments thereof, presented in conjunction with the following drawing.

FIG. 1 is series of fluorometric photographs of the sample fluids of Table 3 following irradiation using 365 nm light.

### DETAILED DESCRIPTION OF THE PREFERRED EMBODIMENTS

A concern that has not gained notice in the aerospace industry, and in particular, one concern with the use of aircraft functional fluids is one of visual perception. Because of the extreme operational parameters, e.g., mechanical stresses, pressure differentials, and environmental conditions mentioned above, it is not uncommon for some hydraulic line seals to exhibit small leaks. The leaks are expected, and therefore, are taken into account in the design of aviation hydraulic systems. In some instances, the leaking of a functional fluid from an aviation hydraulic system can migrate to an external surface of the aircraft. In other words, it might be seen by passengers and cause unnecessary questions, concerns or alarm. Accordingly, to alleviate any such concern a fluorescent dye that imparts little or no color to the fluid would be preferred.

The invention is directed to a fluorescent dye in combination with functional fluids, and in particular, functional fluids associated with aerospace such as aviation mechanical systems. The fluorescent dye is present in the functional fluid from about 0.00005% by weight to about 3% by weight, including from about 0.0001% by weight to about 1% by weight, from about 0.0005% by weight to about 0.1% by weight, and from about 0.0005% by weight to about 0.01% by weight.

The fluorescent dye to be used with the functional fluid can be provided to a commercial customer as a powder, which is directly mixed with the customer's functional fluid. Alternatively, the fluorescent dye to be formulated with a functional fluid, and which can be provided to a commercial customer as a pre-mix or fluid concentrate, e.g., a fluid concentrate in the form of a solution, emulsion or dispersion. For example, the fluorescent dye can be mixed with a functional fluid for a specific application. Alternatively, the fluorescent dye can be mixed with a common fluid that is compatible with or a component of a functional fluid, e.g., an alcohol or glycol such as PEO, to form a dye fluid concentrate. If the fluorescent dye is provided to the customer as a fluid concentrate, it is preferred that the fluid concentrate be stable for a period of at least three months, i.e., there would be no visible settling of the fluorescent dye. Nevertheless, the customer may be requested to stir or shake the fluid concentrate prior to mixing the fluid concentrate with the functional fluid to achieve the target concentration of dye in the functional fluid.

The fluorescent dye in the fluid concentrate can be from about 1% by weight to about 90% by weight, including from about 5% by weight to about 60% by weight, and from about 5% by weight to about 30% by weight. In some instances, depending upon the type of fluorescent dye, and in some cases to maintain even longer storage stability, the amount of fluorescent dye in the concentrate can be from 0.05% to 10% by weight

In addition, the fluid concentrate, or pre-mix concentrate, should contain chemical components that are compatible with the functional fluids, in particular, hydraulic fluids, especially hydraulic fluids that are used in aerospace engineering systems. In one embodiment, the fluid concentrate, for example, can include polyoxyethylene derivatives of various alcohols/glycols, e.g., polyoxyethylene glycols, organic acids or mixtures of the alcohols/glycols and the acids, In particular, the organic acids are straight chain acids containing from 6 to 22 carbon atoms and which can be saturated or unsaturated. These acids can also include polyoxyethylene adducts having from 2 to 20 oxyethylene units. Representative examples of some polyoxyethylene derivatives can include, but are not limited to, polyoxyethylene oleyl ethers, polyoxyethylene cetyl ethers, polyoxyethylene glycol fatty esters, polyoxyethylene lauryl ether, polyoxyethylene stearyl ether, polyoxyethylene olelyl ether, polyoxyethylene tridecyl ether, polyoxyethylene stearate, polyoxyethylene palmitate, and polyoxyethylene cetate. These polyoxyethylene compounds can include from 2 to 20 polyoxyethylene units, for example, from about 8 to about 14, polyoxyethylene units.

In another embodiment, the fluid concentrate can include a succinic ester of a substantially saturated hydrocarbon substituted succinic acid together with a polyhydric alcohol and minor amounts of an alkaline earth metal salt of a fatty acid. The alkaline earth metal salts of fatty acids will typically have at least 12 aliphatic carbon atoms. In addition, one can also include solvents such as alcohols or phenols, e.g., alkylated phenols having from 1 to 3 alkyl substituents, each of which has up to about 20 carbon atoms.

In still another embodiment, the fluid concentrate can include a 2,4,6-trialkylphenol, a dialkylphenyl)amine, a hindered polyphenol compound selected from the group consisting of bis(3,5-dialkyl-4-hydroxyaryl)methane, 1,3,5-trimethyl-2,4,6-tris (3,5-di-tert-butyl-hydroxyaryl)benzene and any one mixture thereof. Such phenol or amine compounds are generally present in the pre-mix concentrate from about 0.5% by weight to about 7% by weight including from 1% by weight to 3% by weight of the concentrate.

Coumarin Class of Dyes

The fusion of a pyrone ring with a benzene ring gives rise to a class of heterocyclic compounds known as benzo-alpha-pyrones, commonly called coumarins. From the viewpoint of molecular structure, coumarins bear a carbon-carbon double bond which is fixed as trans conformation as in trans-stilbene through a lactone structure. This can help to avoid the trans-cis transformation of the double bond under ultraviolet (UV) irradiation as observed in stilbene compounds and results in strong fluorescence and high fluorescence quantum yield and photostability in most of coumarin derivatives.

A coumarin-based fluorescent dye can be of the formula (I),

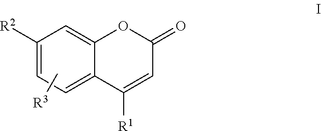

wherein R¹ and R² can be a straight or branched, aliphatic radical with 2 to 12 carbon atom chain that is substituted with at least one substituent group selected from: —OH, —NHR^{a}, —COOR^{a}, —SO₃⁻, —N(R^{a})₂, —OP(O)(OR^{a})₂, —CONH(CH₂)₂OH, —CONHC(CH₂OH)₃, —CONH(CH₂)₂NH(CH₂)₂NH₂, —CONH(CH₂)₂ N[(CH₂)₂ NH₂]₂, —CONH[(CH₂)₂O]₂(CH)₂OR^{a}, —CONH(CH₂)₂OR^{a}, —CONH(CH₂)₂SO₃⁻, —CONH(CH₂)₂COOR^{a}, or —CONH(CH₂)₂N⁺Hₙ(R)₃₋ₙ;

where R^{a} is H or C₁-C₄ alkyl, optionally substituted with one, or two, —OH or —CO₂H; and R³ is independently selected from R^{a}, —NH₂, —NHR^{b}, or —OR^{b}; where R^{b} is C₁-C₄ alkyl; and n is 0, 1, 2 or 3. Preferably, the at least one substituent group is a terminal group of the carbon atom chain. Additionally, the 2-12 carbon atom chain can optionally be substituted with one or more heteroatoms (e.g. O, N, or S). For example, the 2-12 carbon atom chain can optionally be substituted with one or more oxygen atoms such as to form an alkylene oxide chain, e.g., —[CH₂CH₂O]ₙ—.

The coumarin based dyes can be prepared using methods well known to those of ordinary skill in the art of making fluorescent dyes. For example, some of the preparation schemes for the coumarin dyes are outlined in U.S. Pat. No. 5,998,593 to Huff et al, which describes attaching such dyes to enzyme substrates and which is incorporated herein by reference in its entirety.

Another coumarin-based fluorescent dye can be of the formula (II),

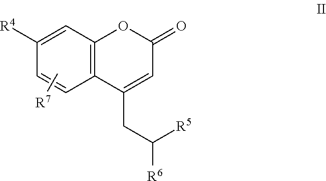

wherein R⁴ and R⁷ are independently selected from H, C₁-C₄ alkyl, optionally substituted with —OH or —CO₂H, —OH, —NH₂, —NHR^{b}, —CO₂H, —OR^{b} where R^{b} is C₁-C₄ alkyl; R⁶ and R⁶ are independently selected from H, a straight or branched, aliphatic radical with 2 to 12 carbon atom chain that is substituted with at least one substituent group selected from: —OH, —NHR^{a}, —COOR^{a}, —SO₃⁻, —N(R^{a})₂, —OP(O)(OR^{a})₂, —CONH(CH₂)₂OH, —CONHC(CH₂OH)₃, —CONH(CH₂)₂NH(CH₂)₂NH₂, —CONH(CH₂)₂ N[(CH₂)₂ NH₂]₂, —CONH[(CH₂)₂O]₂(CH)₂OR^{a}, —CONH(CH₂)₂OR^{a}, —CONH(CH₂)₂SO₃⁻, —CONH(CH₂)₂COOR^{a}, or —CONH(CH₂)₂N⁺Hₙ(R^{b})₃₋ₙ; and n is 0, 1, 2 or 3. Additionally, the 2-12 carbon atom chain can optionally be substituted with one or more oxygen atoms such as to form an alkylene oxide chain, e.g., —[CH₂CH₂O]ₙ—. These coumarin based dyes can be prepared using methods well known to those of ordinary skill in the art of making fluorescent dyes. For example, some of the preparation schemes for these coumarin dyes are outlined in U.S. Pat. No. 5,247,099 to Celebuskis, which is incorporated herein by reference in its entirety.

Fluorescein Based Dyes

In one embodiment, the fluorescent dye compounds are phosphonate derivatives of xanthene-based dyes that are typically fluorescein, rhodamine or rhodol derivatives. The core fluorescein and rhodamine structure are shown below.

“Fluorescein” dyes include derivatives of 3H-xanthen-6-ol-3-one that are typically substituted at the 9-position by a 2-carboxyphenyl group. “Rhodamine” dyes include derivatives of 6-amino-3H-xanthen-3-imine that are typically substituted at the 9-position by a 2-carboxyphenyl group. “Rhodol” dyes include derivatives of 6-amino-3H-xanthen-3-one that are typically substituted at the 9-position by a 2-carboxyphenyl group. Fluoresceins, rhodamines and rhodols are typically substituted by a derivative capable of forming a 5- or 6-membered lactone or lactam ring. Coumarin-based dyes fluoresce in a variety of colors, including blues, greens, reds, and oranges when excited with light in the range of about 365 nm to about 450 nm. In many instances, the blue fluorescing coumarin-based dyes are of interest. Blue coumarin-based dye is typically provided as a dye solution comprising the blue coumarin-based dye and an oil, with the amount of blue coumarin based-dye ranging from about 15 to about 35 weight % of the dye solution.

As stated in-part above, the neutral blending oil should likewise be an inert oil. Examples of inert oils include, but are not limited to mineral oil, light petroleum hydrocarbon, polyalkylene glycol, polyvinyl ether, polyalpha olefin, alkyl benzenes, and polyolester synthetic lubricants.

Naplythalimide Based and Perylene Based Dyes

In one embodiment, the fluorescent dye compounds are naphthalimide dye, or a perylene dye. Green naphthalimide-based dyes fluoresce a brilliant green when exposed to incident radiation of visible violet/blue light. The visible violet/blue range extends from about 400 nm to about 480 nm within the electromagnetic spectrum. Green naphthalimide-based dye is typically provided as a dye solution comprising a green fluorescing naphthalimide-based compound and an oil, with the amount of green fluorescing naphthalimide-based compound ranging from about 30 to about 60 weight % of the dye solution. For example, the fluorescent dye can be a naphthalimide dye mixed with polyol ester oil and a petroleum hydrocarbon. One can also add mineral oil or a perylene dye to the naphthalimide mixture.

Yellow perylene-based dye is typically provided as a dye solution comprising a yellow fluorescing perylene-based compound and an oil, with the yellow fluorescing perylene-based compound comprising from about 17 to about 50 weight % of the dye solution,

Exemplary fluorescent dye packages in a base oil are listed in Table 1 and which are available from Spectronics Corporation, Westbury, N.Y.

TABLE 1
Fluorescent compositions

| Dye Type | Dye Base | Additives |
|---|---|---|
| OIL-GLO 22 | perylene | mineral oil |
| OIL-GLO 30 | perylene, naphthalimide | polyol ester oil, aromatic |
| | and coumarin | |
| OIL-GLO 33 | naphthalimide | polyol ester oil, aromatic |
| OIL-GLO 40 | naphthalimide and | polyol ester oil, aromatic |
| | coumarin | |
| OIL-GLO 44 | perylene and | polyol ester oil, aromatic |
| | naphthalimide | |
| OIL-GLO 50 | perylene | mineral oil |

Many fluorescent dye compounds have a polycyclic aromatic nature and are hydrophobic. One method to overcome this problem is to improve the hydrophilic character of the dye by, for example, introducing a sulfonate substituent into the dye molecule (sulfonated carbocyanine dyes are disclosed in U.S. Pat. No. 5,268,486 and sulfonated xanthene dyes are disclosed in U.S. Pat. No. 6,130,101). The disclosures of U.S. Pat. Nos. 5,268,486 and 6,130,101 are incorporated herein by reference in their entireties.

Another alternative is to substitute at least one phosphonate moiety into the fluorescein, rhodol and rhodamine dye compounds. The phosphonate-substituted dye compounds exhibit relatively high water solubility because the phosphonate group is ionizable, thus providing the needed hydrophilicity to the compounds. Moreover, the quantum efficiency of the phosphonate dye compounds is not significantly impacted by the introduction of a phosphonate moiety.

The “phosphonate dyes” (e.g., dye compounds with a zwitterionic phosphonate group or a protected form thereof) have been found to be compatible with, for example, coumarin dyes, benzocoumarin dyes, fluorescein dyes, rhodol dyes, phenoxazine dyes, benzophenoxazine dyes, xanthene dyes, benzoxanthene dyes, and cyanine dyes.

In one embodiment, the fluorescent dye compound has a general formula FL-(PZ)ₙ, wherein PZ is a zwitterionic phosphonate group having the formula (III)

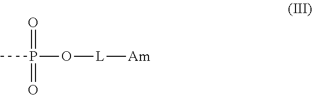

wherein the dotted line indicates the direct attachment to a carbon of the fluorescent dye compound; L is a linking group; Am is an ammonium ion group —NR^{a}R^{b}; each of R^{a} and R^{b} is independently selected from H, or a C₁-C₈ alkyl; and the subscript n is an integer of from 1 to 4, preferably 1 to 2. Suitable dye compounds can be selected from, for example, coumarins, benzocoumarins, xanthenes, benzo[a]xanthenes, benzo[b]xanthenes, benzo[c]xanthenes, cyanines, acridines, dipyrrometheneboron difluorides, phenoxazines, benzo[a]phenoxazines, benzo[b]phenoxazines and benzo[c]phenoxazines. A preferred group of dye compounds is selected from the family of xanthene dyes, including benzoxanthenes, and more specifically, fluorescein dyes, rhodamine dyes and rhodol dyes.

In a number of embodiments, linker L can be a variety of linking groups known to those persons of ordinary skill in the art. Many linking groups are available from commercial sources and can be utilized in the reagents above by coupling one end of the linker to the fluorescent dye and the other end of the linker to a protecting group. In one instance, L is a C₂-C₂₀ alkylene group, e.g., C₂-C₅ alkylene. terminating in a functional group such as hydroxy, amino, carboxy, carboxylate ester, carboxamide, urea, and the like. In other embodiments, L is an alkylene group having an attached phosphoramidite moiety, preferably 2-cyanoethyl-N,N-diisopropylphosphoramidite.

The Functional Fluids:

In one embodiment, the functional fluid is suitable for use as an aircraft hydraulic fluid. In this embodiment, the composition comprises a fire resistant phosphate ester base stock, the base stock comprising between about 10% and about 100%, preferably between about 20% and about 99%, by weight of a trialkyl phosphate, between about 0% and about 70% by weight of a dialkyl aryl phosphate, and from about 0% to about 25% by weight of an alkyl diaryl phosphate, with the proviso that the sum of the proportionate amount of each base stock component must equal 100%. The alkyl substituents of the trialkyl phosphate, the dialkyl aryl phosphate, and the alkyl diary' phosphate contain between 3 and 8 carbon atoms, including between 4 and 8 carbon atoms such as between 4 and 5 carbon atoms, and are bonded to the phosphate moiety via a primary carbon. It is also preferred that the alkyl substituents of the trialkyl phosphate, the dialkyl aryl phosphate, and the alkyl diaryl phosphate are isoalkyl groups and include, but not limited to, isoalkyl C₄ and C₅ isoalkyl groups, e.g., isobutyl and isopentyl (also known as isoamyl), respectively.

In one embodiment, the base stock of the composition comprises between about 50% and about 85% by weight of a trialkyl phosphate, between about 18% and about 35% by weight of a dialkyl aryl phosphate, and from 0 to about 5% by weight of an alkyl diaryl phosphate. In addition to the fire resistant base stock, the composition further comprises an acid scavenger in an amount effective to neutralize phosphoric acid partial esters formed in situ by hydrolysis of any of the phosphate esters of the base stock; an anti-erosion additive in an amount effective to inhibit flow-induced electrochemical or zeta corrosion of the flow metering edges of hydraulic servo valves in hydraulic systems; a viscosity index improver in an amount effective to cause the fluid composition to exhibit a viscosity of at least about 3.0 centistokes (cst) at about 210° F., and at least about 9.0 centistokes at about 100° F., and less than about 4200 centistokes at −65° F.; and an anti-oxidant in an amount effective to inhibit oxidation of the fluid components.

A phosphate ester base stock of interest is one comprising about 60% tri(n-butyl)phosphate, about 10% tri(iso-propylated) aryl phosphate and about 10% tri(n-butyl) phosphate with the proviso that the sum of proportionate amounts of each base stock component together with additives must equal 100%.

One phosphate ester base stock can include one or more C₆-C₁₈ alkylphosphonates, or an amine adduct thereof, or any one mixture thereof, present in the base stock of from 10% to 90% by weight, based on the total components in the base stock (not including water). Suitable alkylphosphonates include those represented by the formula (IV)

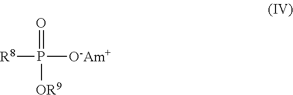

in which R⁸ is a straight or branched aliphatic radical having from about 11 to 40 carbon atoms, and R⁹ is a lower aliphatic radical having from one to eight carbon atoms, and Am+ is ammonium ion or a alkyl substituted amonimum with 1, 2, or 3 alkyl substituents. Some of the more preferred alkylphosphonates include those where at least 75% of the alkyl carbons of R⁸ are in the chain backbone, i.e., a relative linear alkyl is preferred over a significantly branched alkyl, The additive package is prepared by mixing the constituents in a suitable mixer with the one or more fluorescent dyes. The pre-concentrate packages can then emulsified in a set amount of water.

Examples of suitable ammonium alkyl alkanephosphonates include, but not limited to: C₁₄-C₅sec-alkylmethylammonium methyl-n-tetradecylphosphonate, dodecylmethylammonium methyl-n-octadecylphosphonate, octadecylethylammonium methyl-n-octadecylphosphonate, tetradecylbutylammonium ethyl-n-hexadecylphosphonate, dioctylammonium methyl-n-dodecylphosphonate, 3-(N-n-octadecylamino)propylmethylammonium methyl-n-tetradecylphosphonate, 3-(N-n-dodecylamino)propylethylammonium methyl-n-dodecylphosphonate, n-Butylmethylammonium methyl-n-tetradecylphosphonate, 3-Aminopropyl-n-octadecylmethylammonium methyl-n-tetradecylphosphonate, 3-Aminopropyl-n-dodecylmethylammonium methyl-n-tetradecylphosphonate, dodecylmethylammonium methyl-n-hexadecanephosphonate, dodecylmethylammonium methyl-n-C.sub.12.sub.-18 alkyiphosphonates, n-Tetradecyltrimethylammonium-methyl-n-tetradecylphosphonate, and di-n-dodecyldimethylammonium-methyl-n-tetradecylphosphonate,

The phosphonate base stock can also include a dihydrocarbyl dithiophosphate, where “dihydrocarbyl” is alkyl, and are generally made from a dithiophosphoric acid having the formula: (R¹⁰O)P(S)(SH), wherein R¹⁰ comprises an alkyl group containing about 1 to about 30 carbon atoms. The hydrocarbyl groups originate from primary alcohol, examples of which are normal alcohols such as n-heptyl, n-octyl, n-decyl, and n-dodecyl or from branched chain alcohols such as methyl- or ethyl-branched isomers of the above. Suitable branched alcohols are 2-methyl-1-pentanol, 2-ethyl-1-hexanol, 2,2-dimethyl-1-octanol, and alcohols prepared from olefin oligomers such as propylene dimer or trimer by hydroboration-oxidation or by the Oxo process, The dialkyl dithiophosphoric acids are generally made by reaction of about 4 moles of alcohol with one mole of a phosphorus pentasulfide containing about 27 weight percent phosphorus. Additional information on the dihydrocarbyl dithiophosphate can be found in U.S. Pat. No. 4,253,975 to Law et al., the disclosure of which is incorporated herein by reference in its entirety.

Fluid Additives

The aviation hydraulic fluid can also include one or more additives. The fluid can include a viscosity index improver in a proportion, on a solids (methacrylate polymer, infra) basis, of between about 3% and about 10% by weight of the fluid. The viscosity index improver can include a methacrylate ester polymer, the repeating units of which substantially comprise butyl and hexyl methacrylate as described in U.S. Pat. No. 3,718,596, which is incorporated herein by reference in its entirety. Generally, the viscosity index improver is of high molecular weight, having a number average molecular weight of between about 50,000 and about 100,000 and a weight average molecular weight of between about 200,000 and about 300,000. The viscosity index improver can be provided in the form of a solution in a phosphate ester solvent, preferably a trialkyl phosphate ester, such as, for example, tributyl or triisobutyl phosphate, or a combination of alkyl and aryl phosphate esters. In a preferred embodiment, the phosphate ester solvent is comprised of one or more of the phosphate ester components which constitute the phosphate ester base stock.

The hydraulic fluid can further include an anti-erosion agent in a proportion of between about 0.02% and about 0.08% by weight of the fluid, the anti-erosion agent comprising an alkali metal salt of a perfluoroalkylsulfonic acid, the alkyl substituent of which is hexyl, heptyl, octyl, nonyl or decyl. The fluid can also include an acid scavenger in a proportion of between about 1.5 and about 10% by weight of the composition. For example, the acid scavenger comprising could be a derivative of 3,4-epoxycyclohexane carboxylate or a diepoxide compound of the type disclosed in U.S. Pat. No. 4,206,067, which is incorporated herein by reference in its entirety.

A copper corrosion inhibitor can also be included in the fluid such as a benzotriazole derivative sold under the trade designation Petrolite™ 57068 by Baker Hughes. This corrosion inhibitor is present in an amount sufficient to deactivate metal surfaces in contact with the fluid composition against the formation of metal oxides on the metal surfaces in contact with the fluid, thereby reducing rates of copper dissolution into the hydraulic fluid, and also reducing dissolution of perhaps parts fabricated from copper alloys.

Another corrosion inhibitor can also be included in the fluid such as certain 4,5-dihydroimidazole compounds, which are known to be effective iron corrosion inhibitors, yet do not adversely affect the erosion properties of the fluid. The presence of such a 4,5-dihydroimidazole compound, typically in a proportion of between about 0.01% and about 0.1% by weight, not only inhibits iron corrosion but contributes markedly to the stability of the functional fluid as indicated by epoxide depletion.

Other additives include corrosion inhibitors such as dihydroimidazole and diphenyldithio ethane, a combination of anti-oxidants such as butylated hydroxyl toluene, 1,3,5 trimethyl-2,4,6 tris(BHT)benzene and dioctyldiphenyl amine. Still other additives include acid scavengers such as ethylhexyl-epoxycyclohexyl carboxylate and foam inhibitors such as silicone oil.

As noted above, the phosphate ester base stocks of this invention contain many additives as is well known in the art to provide various beneficial properties to the fluid or aid in preventing degradation or the effects of degradation during use. Such additives are described in RE. 37,101 to Deetman, the entire disclosure of which is incorporated herein by reference.

The invention is also directed to a method of detecting a leak in a mechanical system that contains such fluids. To detect leaks in a mechanical system such as a hydraulic system, and in particular, a hydraulic system used in the aviation industry one can provide a hydraulic fluid that includes a fluorescent dye compound. Upon the leakage of hydraulic fluid, the hydraulic fluid can be detected by irradiating certain prone areas of the airplane with a select spectrum of light, e.g., a light source that emits ultraviolet, blue or violet light, or combinations thereof. For example a light source with a long wave ultraviolet (UV-A) wavelength range (about 315 nm to about 400 nm) through the visible violet/blue range (from about 400 nm to about 480 nm) can be used. In the preferred embodiment, the light source is designed to emit light in a wavelength between about 365 nm and about 450 nm.

The irradiation of the dye compound, which was included in the hydraulic fluid, with the light source provides an excited state of the dye, and upon relaxation, the dye will emit a wavelength of light. Preferably, the emitted light would be in the visible range of the light spectrum, and therefore, visible to the human eye. Alternatively, the emitted light could be magnified and/or observed with the help of specialized optical equipment, such as specifically colored eyewear capable of observing and/or enhancing the fluorescence generated by the dye compound.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

### EXAMPLES 1 TO 4

A variety of different fluid composition were prepared for evaluation. Table 2 lists pre-mix concentrates with varying concentrations of a coumarin-based, fluorescent dye solid: 1%, 2%, 5% and 10% by weight. The fluorescent dye was mixed with an aviation hydraulic fluid sold under the trade designation of Skydrol® 5 sold by Eastman Chemical to form a pre-mix.

TABLE 2

| Example | | Phosphate Ester Oil | % Dye in PEO |
|---|---|---|---|
| Number | Coumarin dye (g) | (PEO) (g) | Concentrate |
| 1 | 0.045 | 4.5 | 1 |
| 2 | 0.090 | 4.5 | 2 |
| 3 | 0.225 | 4.5 | 5 |
| 4 | 0.450 | 4.5 | 10 |

### EXAMPLE 5

Table 3 list samples of functional fluids prepared from each of the above fluid concentrates, Examples 1 to 4. Each of the Example 1 to 4 fluid concentrates were further diluted with Skydrol® 5 to provide sample numbers 5 to 16 using different application ratios. The term “application ratio” is defined as an ounce of fluid concentrate per gallon of functional fluid.

TABLE 3

| Sample | % Dye in PEO | PEO-Dye | Functional | Application | % Dye in |
|---|---|---|---|---|---|
| Number | Concentrate | Concentrate (g) | Fluid (g) | Ratio^{a} | Functional Fluid |
| 5 | 1 | 0.010 | 4.5 | 1:4 | 0.0020 |
| 6 | 1 | 0.005 | 4.5 | 1:8 | 0.0010 |
| 7 | 1 | 0.003 | 4.5 | 1:12 | 0.0007 |
| 8 | 2 | 0.010 | 4.5 | 1:4 | 0.0040 |
| 9 | 2 | 0.005 | 4.5 | 1:8 | 0.0020 |
| 10 | 2 | 0.003 | 4.5 | 1:12 | 0.0013 |
| 11 | 5 | 0.010 | 4.5 | 1:4 | 0.0010 |
| 12 | 5 | 0.005 | 4.5 | 1:8 | 0.0049 |
| 13 | 5 | 0.003 | 4.5 | 1:12 | 0.0033 |
| 14 | 10 | 0.010 | 4.5 | 1:4 | 0.0200 |
| 15 | 10 | 0.005 | 4.5 | 1:8 | 0.0010 |
| 16 | 10 | 0.003 | 4.5 | 1:12 | 0.0065 |

^{a}Application ratio is defined as an ounce of PEO-Dye Concentrate per gallon of Functional Fluid (Skydrol ® 5).

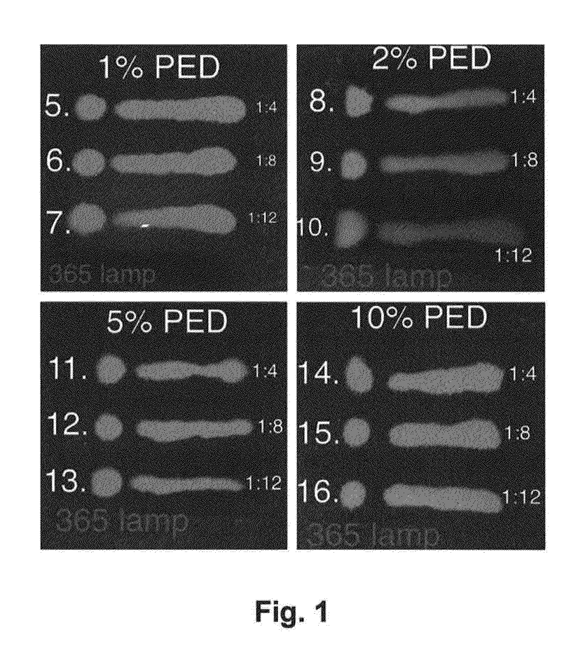

Fluorometric photographs of the sample fluids of Table 3 were obtained using 365 nm light. The fluorescent light emission is shown in FIG. 1.

### EXAMPLE 6

Example 3 (fluorescent dye in phosphate ester oil (PEO)) was further diluted with Skydrol® 5 with an application ratio of 1:6. We then conducted a flashpoint analysis of the functional fluid with the dye. We observed that the very small concentration of fluorescent dye to the functional fluid actually increased the flashpoint of the fluid, which is an unexpected benefit. See Table 4.

TABLE 4
Flash Point Analysis ASTM D92 COC

| Sample | Value (° C.) | Value (° F.) |
|---|---|---|
| Phosphate Ester Oil | 152 | 306 |
| Dye Concentrate Solution | 174 | 345 |
| Dye Solution in Application Ratio | 172 | 342 |

We also conducted a particle count analysis on the PEO and Example 6. The fluorescent dye present in Example 6, however, has little, if any, effect on particle count relative to the neat functional fluid, Skydrol® 5. Moreover, one also observes that the dye has little, if any, effect on the viscosity, or the total acid number of Skydrol® 5. See, data included in Table 5. Accordingly, the addition the fluid concentrate of Example 3 provided a lower acid number, little or no measurable change in viscosity, that is, a change in viscosity of no more than 5%, preferably, no more than 2%, and little or no change in particle content, that is, a change in particle content of no more than 5%, preferably, no more than 2%, each value relative to the functional fluid.

TABLE 5

| | Acid | | | | |
|---|---|---|---|---|---|
| | number | | | | Nitration |
| | mg | Viscosity | ISO Code | Oxidation | abs/ |
| Fluid | KOH/g | 40° C., cSt | 4406 | Abs/cm | 0.1 mm |
| Skydrol ® 5 | 0.03 | 3.2 | 25/24/16 | 54 | 5 |
| Example 3 | 0.01 | 3.3 | 25/22/16 | 49 | 5 |
| Example 6 | 0.01 | 3.2 | 25/23/16 | 45 | 5 |

Particle Count Analysis: ISO 4406

ISO 4406 is the reporting standard for fluid cleanliness. The reported particle count values are derived at three different micron levels: greater than 4 microns, greater than 6 microns and greater than 14 microns. The unit of measure for particle count data is “particles per milliliter of sample.” For example, if approximately 100 milliliters of sample are used in a measurement, the number of particles counted are based on a 100 mL sample size. The total number of particles is then compared to the number of times that 2 will go into that total count exponentially. So for Example 6 in Table 5, the reported values (25/23/16), means that at the greater than 4 micron level, the number of particles measured was at the most 2²⁵ and above 2²⁴.

The steps of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

We claim:

1. A fluid concentrate comprising a fluorescent dye and an aviation functional fluid, and the fluorescent dye is present in the functional fluid from 0.05% by weight to 10% by weight.

2. The fluid concentrate of claim 1, wherein the functional fluid comprises 20% to 99%, by weight of a phosphonate selected from the group consisting of a trialkyl phosphonate, a C₆-C₁₅ alkylphosphonates or an amine adduct thereof, a dihydrocarbyl dithiophosphate, and any one mixture thereof.

3. The fluid concentrate of claim 1, wherein the fluorescent dye is selected from a coumarin-based dye a fluorescein-based dye, or any one mixture thereof.

4. A functional fluid comprising:
20% to 99%, by weight of a phosphonate selected from the group consisting of a trialkyl phosphonate, a C₆-C₁₈ alkylphosphonates or an amine adduct thereof, a dihydrocarbyl dithiophosphate, and any one mixture thereof; and
0.00005% to 3% by weight of a fluorescent dye, wherein the functional fluid is an aviation functional fluid.

5. The functional fluid of claim 4, wherein the fluorescent dye is present from 0.0005% by weight to 0.1% by weight.

6. The functional fluid of claim 4, wherein the fluorescent dye is a coumarin-based dye.

7. The functional fluid of claim 4, wherein the fluorescent dye is a fluorescein-based dye.

8. The functional fluid of claim 4, further comprising a dialkyl aryl phosphate, an alkyl diaryl phosphate, or any one mixture thereof.

9. A fluid concentrate comprising:
1% by weight to 90% by weight of a fluorescent dye; and
0.5% to 7% by weight of one or more compounds selected from 2,4,6-trialkylphenol, a dialkylphenyl)amine, a polyphenol compound selected from the group consisting of bis(3,5-dialkyl-4-hydroxyaryl)methane, 1,3,5-trimethyl-2,4,6-tris (3,5-di-tert-butyl-hydroxyaryl)benzene and any one mixture thereof, or any one mixture thereof, wherein the total amount of the one or more compounds does not exceed 20% by weight.

10. The fluid concentrate of claim 9, wherein the fluorescent dye is present from 3% to 30% by weight.

11. The fluid concentrate of claim 9, wherein the fluorescent dye is a coumarin-based dye.

12. The fluid concentrate of claim 9, wherein the fluorescent dye is a fluorescein-based dye.

13. A method of detecting a leak in an aviation mechanical system, the method comprising;
providing a fluid concentrate that includes a fluorescent dye,
mixing the fluid concentrate with a functional fluid, and
irradiating select areas of the airplane with a select spectrum of light to observe an emission from the fluorescent dye.

14. The method of claim 13, wherein the fluid concentrate is added to the aviation mechanical system that includes the functional fluid.
